(19) United States
(12) Patent Application Publication
(10) Pub. No.: US 2007/0120620 A1
(43) Pub. Date: May 31, 2007

(54) TUNABLE SURFACE MOUNT CERAMIC COUPLER

(75) Inventors: Simon Donald Gay, Medford, MA (US); Thomas James Dowling, Port Jefferson, NY (US)

Correspondence Address: BOND, SCHOENECK & KING, PLLC, ONE LINCOLN CENTER, SYRACUSE, NY, 13202-1355, US

(73) Assignee: ANAREN, INC., East Syracuse, NY (US)

(21) Appl. No.: 11/383,616

(22) Filed: May 16, 2006

Related U.S. Application Data
(60) Provisional application No. 60/681,343, filed on May 16, 2005.

(51) Int. Cl. H01P 5/18

(52) U.S. Cl. 333/116

(57) ABSTRACT

A coupler is provided that includes a floating, exposed ground plane that can be partially removed to alter the coupling coefficient of the coupler's transmission lines. According to one embodiment, the coupler is formed using low temperature co-fired ceramic techniques to provide a small, stable and durable device suitable for installations in which miniaturization is required.

### PRIORITY CLAIM

This application claims priority to U.S. Provisional Patent Application Ser. No. 60/681,343, filed May 16, 2005.

### BACKGROUND OF THE INVENTION

The present invention relates to couplers used in electronic circuits. Specifically, it relates to a coupler that can be adjusted post-assembly.

### SUMMARY OF THE INVENTION

The technology used in components for satellite, military, and digital communication systems has advanced substantially, with significant reductions in size, operation at higher frequencies, increases in bandwidth, and lower power consumption for a given power output, among other improvements. Generally, satellite, military, and digital communication systems employ microwave technology, which typically operates at frequencies from approximately 500 MHz to approximately 60 GHz or higher. Many of these systems use couplers, such as directional couplers, in their circuitry.

A directional coupler is a linear, passive, four-port device consisting of two parallel transmission lines in close proximity. One of the lines is a “main signal line” that connects an input port of the coupler to an output port. The other of the lines is an “auxiliary signal line.” The auxiliary line is coupled to the main line through a “coupling region” where the lines are in close proximity to each other. When a signal passes through the main signal line, a portion of the signal is electromagnetically coupled into the auxiliary line creating a signal in the opposite direction, with a phase difference of 90 degrees. Maximum signal coupling between the pair of coupled lines is achieved when the length of the coupling region is an odd multiple of a quarter wavelength of the signal traveling on the main line. Because the electrical length of the directional coupler generally must be a multiple of a quarter wavelength at the center frequency, it is necessary to precisely design couplers for their given application.

Directional couplers are employed in a variety of electronic applications. There is a need to minimize the size and weight of couplers that are used in satellite, military, and digital communication systems, for example. Traditional couplers, especially those that operate at lower frequencies, are sometimes laid out with straight, closely spaced conductive traces utilizing long parallel lengths to provide the coupling region. The physical size of such couplers is a function of the wavelength of the coupled signal. Such couplers are useful for some applications but tend to be too long for installation in applications that require miniaturized components, such as the satellite, military, and digital communication industry.

Still other couplers include spiral main and auxiliary signal lines in face-to-face, mirror image relationship in two parallel planes. Such couplers have reduced size, but if they are not carefully designed, they produce an undesirable amount of capacitive coupling between the windings, which causes the amount of coupling to increase undesirably with frequency. Preferably, the amount of coupling should remain generally consistent over the device's bandwidth of operation. Moreover if not properly designed, such structures produce parasitic coupling between the traces which also distorts the device's coupling characteristic over the bandwidth of operation.

Circuit design for satellite, military, and digital communication systems also requires the optimization of circuit components for operation in the selected frequency band(s). Line impedances and lengths that are optimized for a first frequency band may provide inferior performance when used for other bands, either due to impedance variations and/or variations in electrical length. Such limitations can limit the effective operational frequency range for a given system.

Accordingly there is a need for economical directional coupler structures, which have minimal space and weight requirements that are suitable for installation in satellite, military, and digital communication systems. Also it is desirable for such couplers to provide minimal insertion losses and maximum coupling efficiencies. Additionally it is desired to provide couplers which have a constant coupling sensitivity over the bandwidth of operation and which minimize parasitic coupling. Moreover it is desirable to provide a rugged, reliable coupler structure that does not require hand placement and which is economical to manufacture.

It is therefore a principal object and advantage of the present invention to provide a surface mounted coupler that is durable, economically produced and easily adjustable after it has been assembled.

In accordance with the foregoing objects and advantages, the present invention provides a coupler having substrate, a first transmission line formed on the substrate, a second transmission line formed on the substrate in generally parallel co-planar relationship with the first transmission line, each of the first and second transmission lines having a first port and a second port, a floating ground plane in a generally parallel relationship to the first and second transmission lines, the ground plane separated from the transmission lines by dielectric material.

The present invention provides a coupler circuit realized with a Low Temperature Co fired Ceramic (LTCC) manufacturing technology, including a floating ground plane that is tunable post-production.

The coupler according to the present invention can operate at wireless bands around 1.8 GHz, as well as other wireless bands, e.g., 900 MHz, 2.4 GHz, 5.2 GHz, etc. This coupler circuit can be used as a building block in other RF circuits such as voltage variable attenuators, voltage variable phase shifters and vector modulators. The coupler circuit can be used in any wireless application where a two way split with a 90 degree phase differential is required.

The coupler of the present invention, comprises a ceramic coupler circuit that can be tuned—post processing—for improved RF performance. Tuning is achieved by altering the size of an exposed floating ground plane, preferably, by laser ablation of selected portions of the floating ground plane. The ceramic coupler has higher power handling capability than equivalent circuits manufactured in soft board materials such as FR4 and Rogers 4003.

### BRIEF DESCRIPTION OF THE DRAWINGS

The present invention will be more fully understood and appreciated by reading the following Detailed Description in conjunction with the accompanying drawings, in which:

FIG. 1 is an exploded, perspective view of the present invention showing each layer in relation to the others; and

FIG. 2 is a side view of a component stackup showing the composition of each layer of the present invention.

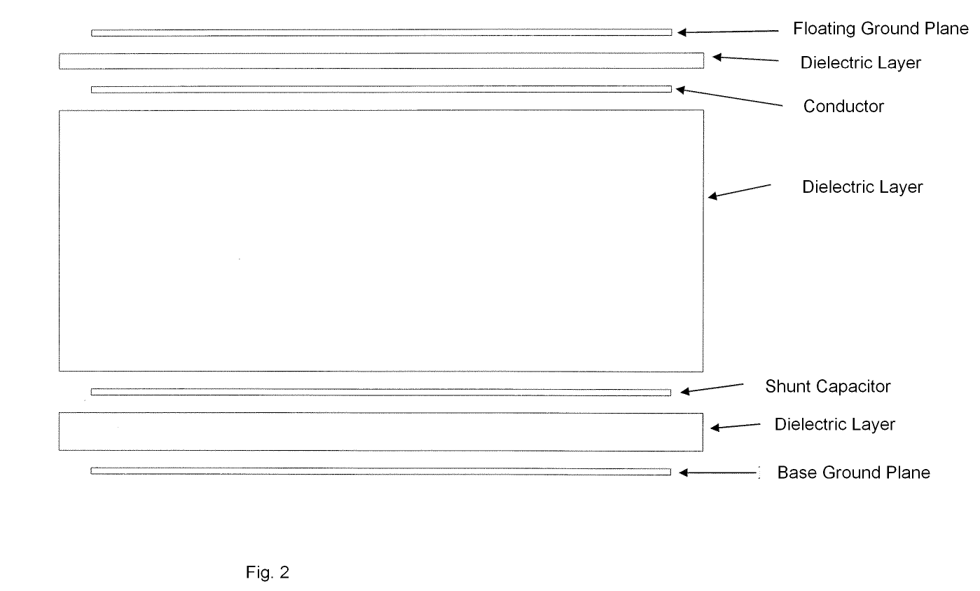

### DETAILED DESCRIPTION

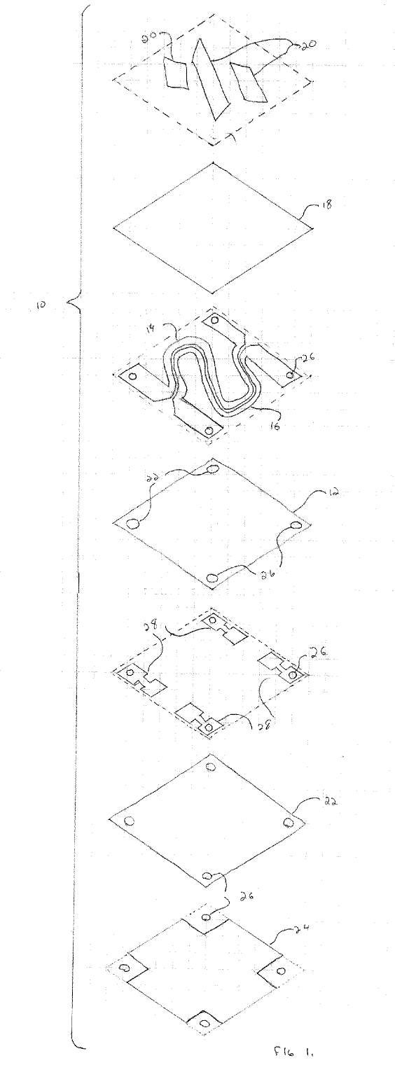

Referring now to the drawings, wherein like reference numerals refer to like parts throughout, there is seen in FIG. 1 a coupler 10 having a first dielectric layer 12, conductors 14, 16, second dielectric layer 18, floating ground plane 20, third dielectric layer 22 and base ground plane 24. Conductors 14, 16, each are connected to vias 26, which pass through other layers of the coupler 10 and serve as ports to electrically connect conductors 14, 16 to a circuit board or other external assembly (not shown). Vias 26 are electrically isolated from the floating ground plane 20 and base ground plane 24. According to one embodiment, vias 26 are approximately 20 mil in diameter. According to another embodiment, each via 26 is comprised of a plurality of vias (preferably four), each approximately 5 mil in diameter. Preferably, vias 26 pass only through the conductors 14, 16, first dielectric layer 12, capacitor plates 28 and third dielectric layer 22, and form a contact/connection pad on the outer surface of third dielectric layer 22. Vias 26 do not pass through second dielectric layer 18.

First dielectric layer 12, second dielectric layer 18 and third dielectric layer 26 are formed of ceramic material as is known in the art. Conductors 14, 16, floating ground plane 20 and base ground plane 24 are metallic. According to the present invention, floating ground plane 20 remains exposed after coupler 10 is assembled, allowing the size and shape of floating ground plane 20 to be modified, post-assembly. According to one embodiment, floating ground plane 20 is comprised of a single metallic pad. According to other embodiments, however, floating ground plane 20 is comprised of a plurality of metallic pads.

The utilization of an LTCC manufacturing process allows the re entrant coupler to be formed on multiple ceramic layers with via interconnections between layers. Conductors 14, 16 are two edge-coupled lines that perform like a 3dB coupler with an electrical line length of 90 degrees. According to the preferred embodiment, conductors 14, 16 have a meander shape to reduce the size of coupler 10. The actual electrical line length of conductors 14, 16 in this circuit is less than 90 degrees. This reduction in line length allows a smaller footprint for the circuit.

An ideal edge coupled 3dB coupler has a coupling coefficient of 0.707. According to the present invention, conductors 14, 16 have a coupling coefficient of less than 0.707 and non ideal line impedances. This compromise in coupling coefficient is compensated for by floating ground plane 20, which is over both of conductors 14, 16 and by adding tuning capacitors to each port. The coupling coefficient of less than 0.707 is due in part to the shorter electrical line length of conductors 14, 16 and due in part to the distance between conductors 14, 16 (i.e. the further conductors 14, 16 are from each, the less they will couple).

This floating ground plane 20 adds capacitive coupling between conductors 14, 16 and effectively increases the coupling coefficient to 0.707 such that the circuit performance approaches that of an ideal 3dB coupler. An alternative way of considering the floating ground plane 20 is that it allows tuning of the odd and even mode line impedance ratio.

The coupling coefficient between conductors 14, 16 is proportional to the size of floating ground plane 20 and the proximity of floating ground plane 20 to conductors 14, 16. Preferably, second dielectric layer 18, which separates conductors 14, 16 from floating ground plane 20, is approximately 1.7 mil thick. According to the present invention, the circuit performance of coupler 10 is changed or improved by changing the size of floating ground plane 20. For example, the size of floating ground plane 20 can be changed by removing portions of the floating ground plane 20 with a laser, effectively changing the ratio of even mode impedance to odd mode impedance.

Coupler 10 has vias 26, which provide electrical connection to an input port, two output ports that are 90 degrees out of phase with each other and an isolated port which ideally has zero power out. The impedance of each of these ports is tuned using shunt capacitors. A plate 28 of each shunt capacitor is formed on an internal layer of the LTCC stack and all of the plates 28 are coupled to the base ground plane 24 of the coupler 10. Higher capacitance density is achieved by forming the capacitor plate 28 as a metal layer on the third dielectric layer 22, so that capacitor plates 28 are in close proximity to the base ground plane 24 of the coupler 10. Shunt capacitor plates 28 can be a modified “hourglass” shape (as shown in FIG. 1), rectangular, or other shapes as is known in the art. Preferably, third dielectric layer, which separates capacitor plates 28 from the base ground plane 24 is approximately 4.2 mils in thickness.

The use of a ceramic material to realize this circuit allows the circuit to handle more power than a coupler circuit fabricated with a material with a lesser thermal conductivity such as FR4 or Rogers 4003 organic dielectrics. This benefit is related to the fact that the conductive lines will heat up as the power the circuit is transmitting is increased—the ceramic dielectric will allow this heat to dissipate away from a hot area more easily than an organic dielectric material.

As previously mentioned variations of this circuit can be designed to resonate at different wireless bandwidths.

When using this re entrant coupler 10 as a building block for other higher functionality circuits such as voltage variable attenuators, phase shifters, and vector modulators, the exposed floating ground 20 plane is key to tuning circuit performance and compensating for variations in diode (or other active component) performance.

What is claimed is:

1. A coupler for use in electronic circuits, comprising:
a first dielectric layer;
a first conductor formed on said first dielectric layer, said conductor having a first and second end;
a second conductor formed on said first dielectric layer, in spaced apart, parallel relationship with said first conductor, said second conductor having a first and second end;
a floating ground plane in generally overlaying relation to said conductors and separated from said conductors by a second dielectric layer;
a base ground plane separated from said first dielectric layer by a third dielectric layer;
wherein said floating ground plane is modified to alter the degree of electromagnetic coupling between said first and second conductors.

2. The coupler of claim 1 wherein said dielectric layers are comprised of ceramic material.

3. The coupler of claim 2 formed in a low temperature co-fired ceramic assembly.

4. The coupler of claim 1 further comprising shunt capacitors formed in a layer between said conductors and said base ground plane, at least one shunt capacitor in electrical connection with each of said conductors' first and second ends.

5. The coupler of claim 1 wherein said floating ground plane is modified by removing selected portions to achieve a desired degree of electromagnetic coupling between said first and second conductors.

6. The coupler of claim 1 further comprising at least one via in electrical communication with each end of each of said conductors, said at least one via also in electrical communication with at least one port for electrically connecting said conductors to a circuit.

7. The coupler of claim 6 wherein said at least one via is a plurality of vias.

8. The coupler of claim 1 wherein said floating ground plane comprises a plurality of segments.

9. A coupler for use in an electronic circuit, said coupler formed in a low temperature co-fired ceramic assembly and comprising:
a floating ground plane formed on a first dielectric layer;
a pair of conductors in parallel, spaced apart relationship, formed on a second dielectric layer and separated from said floating ground plane by said first dielectric layer, each conductor having a first and second end;
at least one shunt capacitor in electrical communication with each end of each of said conductors;
at least one via in electrical communication with each end of each of said conductors and also in electrical communication with a port for electrically connecting the coupler to the electronic circuit; and
a base ground plane separated from said second dielectric layer by a third dielectric layer;
wherein the size and shape of said floating ground plane can be modified selectively to vary the coefficient of coupling between said pair of conductors.

10. The coupler of claim 9 wherein said at least one via is a plurality of vias.
